(19) United States
(12) Patent Application Publication
(10) Pub. No.: US 2014/0165532 A1
(43) Pub. Date: Jun. 19, 2014

(54) System and method for improving the efficiency of a jet engine

(71) Applicant: Vladimir Clue, Cambridge, MA (US)

(72) Inventor: Vladimir Clue, Cambridge, MA (US)

(21) Appl. No.: 13/716,493

(22) Filed: Dec. 17, 2012

(51) Int. Cl. F02K 1/28

(52) U.S. Cl. CPC F02K 1/28
USPC 60/204; 60/770

(57) ABSTRACT

A method of improving efficiency comprises providing an impulse reaction engine having an exhaust and providing a cascading pipe comprising an exhaust intake having a first diameter, approximately cylindrical walls having a second diameter greater than the first diameter, the approximately cylindrical walls having a first end and a second end, the first end connected to the exhaust intake via a plate comprising at least one orifice, and a fluid injector connected to the at least one orifice and configured to direct fluid in a direction substantially parallel to the approximately cylindrical walls and toward the second end. The method further comprises connecting the exhaust intake of the cascading pipe to the exhaust of the impulse reaction engine and injecting fluid via the fluid injector into the cascading pipe so as to cool exhaust gases emitted from the exhaust of the impulse reaction engine.

### BACKGROUND OF THE INVENTION

The present invention relates to efficiency improvement and urban customizing to a Jet Engine.

Water jets are inefficient for large ships, air jets produce too much heat to be used in an urban environment. There is also a need to make flow more laminate. Existing jet engines are much too inefficient and, in case of air jet engines, are dangerous to be used in urban areas.

As can be seen, there is a need for solutions to these and other problems.

### SUMMARY OF THE INVENTION

In one aspect of the present invention, a method of improving efficiency comprises the steps of: providing an impulse reaction engine having an exhaust; providing a cascading pipe comprising: an exhaust intake having a first diameter; approximately cylindrical walls having a second diameter greater than the first diameter, the approximately cylindrical walls having a first end and a second end, the first end connected to the exhaust intake via a plate comprising at least one orifice; and a fluid injector connected to the at least one orifice and configured to direct fluid in a direction substantially parallel to the approximately cylindrical walls and toward the second end; connecting the exhaust intake of the cascading pipe to the exhaust of the impulse reaction engine; and injecting fluid via the fluid injector into the cascading pipe so as to cool exhaust gases emitted from the exhaust of the impulse reaction engine.

In one aspect, the fluid comprises air. In one aspect, the fluid comprises water. In one aspect, the impulse reaction engine comprises a jet engine. In one aspect, the impulse reaction engine comprises a water jet.

In one aspect, the method further comprises the steps of: providing a second cascading pipe comprising: second approximately cylindrical walls having a third diameter greater than the second diameter, the second approximately cylindrical walls having a third end and a fourth end, the third end connected to the second end of the cascading pipe via a second plate comprising at least one second orifice; and a second fluid injector connected to the at least one second orifice and configured to direct fluid in a direction substantially parallel to the second approximately cylindrical walls and toward the fourth end; and injecting fluid via the second fluid injector into the second cascading pipe so as to cool exhaust gases emitted from the exhaust of the impulse reaction engine.

According to one embodiment of the present invention, a system of improving efficiency comprises: an impulse reaction engine having an exhaust; a cascading pipe comprising: an exhaust intake having a first diameter; approximately cylindrical walls having a second diameter greater than the first diameter, the approximately cylindrical walls having a first end and a second end, the first end connected to the exhaust intake via a plate comprising at least one orifice; and a fluid injector connected to the at least one orifice and configured to direct fluid in a direction substantially parallel to the approximately cylindrical walls and toward the second end; wherein the exhaust intake of the cascading pipe is connected to the exhaust of the impulse reaction engine, and wherein the fluid injector is configured to inject fluid into the cascading pipe so as to cool exhaust gases emitted from the exhaust of the impulse reaction engine.

In one aspect, the system further comprises a second cascading pipe comprising: second approximately cylindrical walls having a third diameter greater than the second diameter, the second approximately cylindrical walls having a third end and a fourth end, the third end connected to the second end of the cascading pipe via a second plate comprising at least one second orifice; and a second fluid injector connected to the at least one second orifice and configured to direct fluid in a direction substantially parallel to the second approximately cylindrical walls and toward the fourth end, wherein the second fluid injector is configured to inject fluid into the second cascading pipe so as to cool exhaust gases emitted from the exhaust of the impulse reaction engine.

These and other features, aspects and advantages of the present invention will become better understood with reference to the following drawings, description and claims.

### BRIEF DESCRIPTION OF THE DRAWINGS

FIG. 1: is a perspective view of the invention.

FIG. 2: is a section view of the invention taken along line 2-2 in FIG. 1.

FIG. 3: is a perspective view of the invention.

FIG. 4: is a section view of the invention taken along line 4-4 in FIG. 3.

FIG. 5: is a perspective view of the invention.

FIG. 6: is a section view of the invention taken along line 6-6 in FIG. 5.

FIG. 7: is a perspective view of the invention.

FIG. 8: is a section view of the invention taken along line 8-8 in FIG. 7.

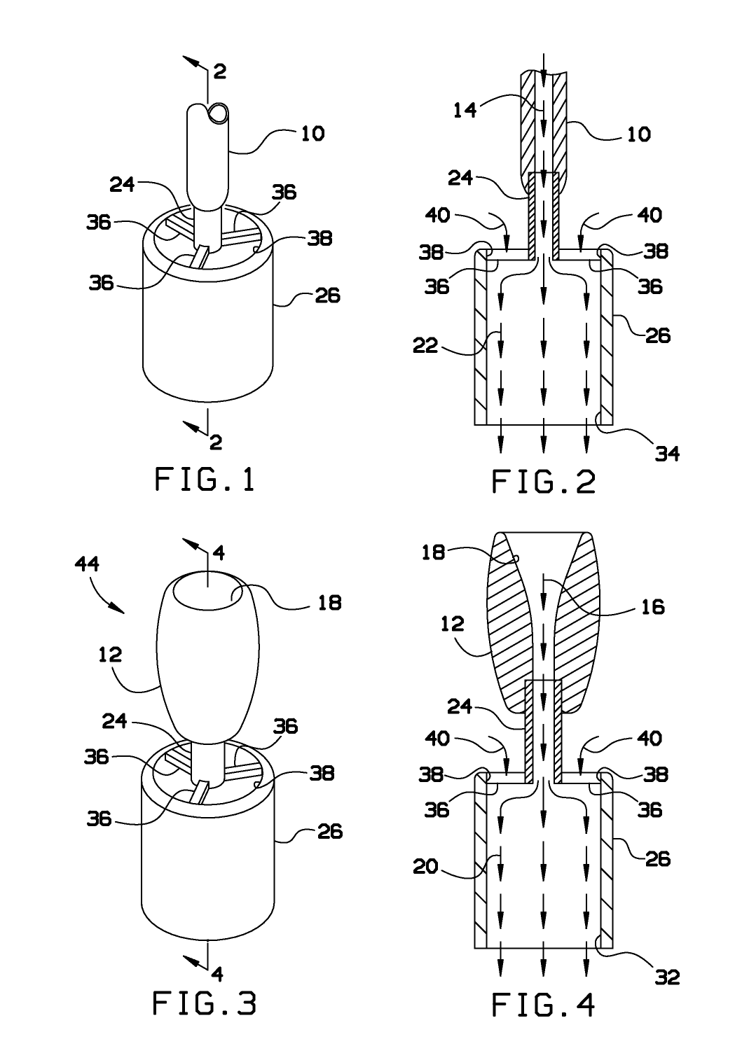

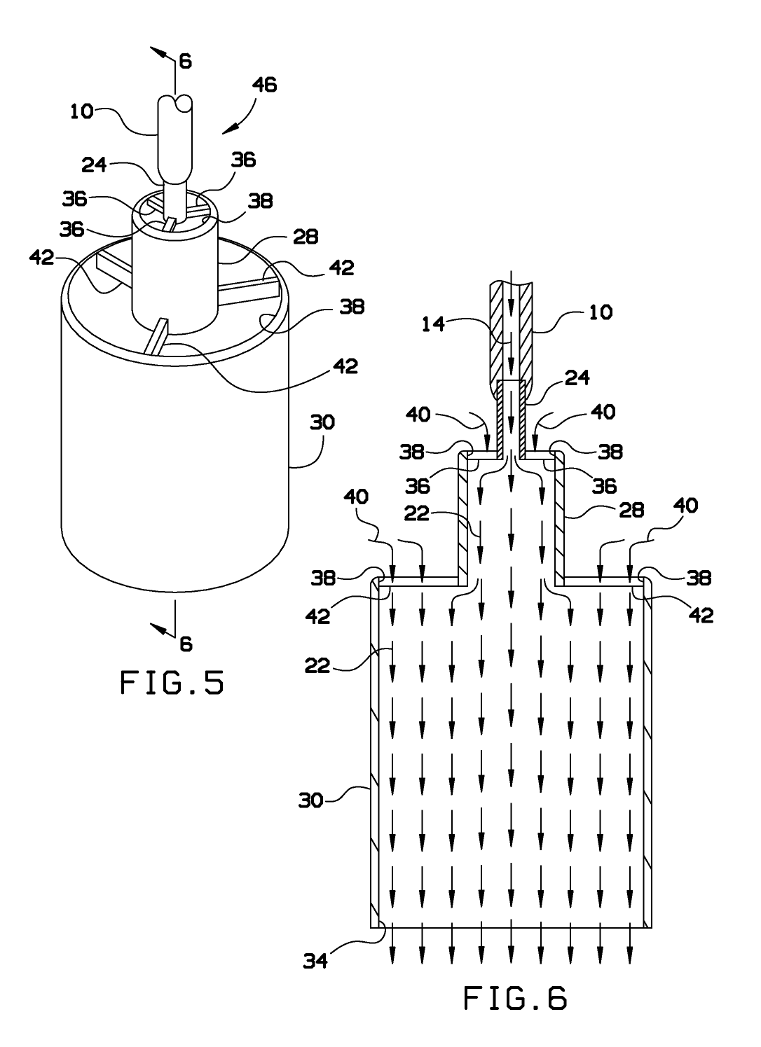

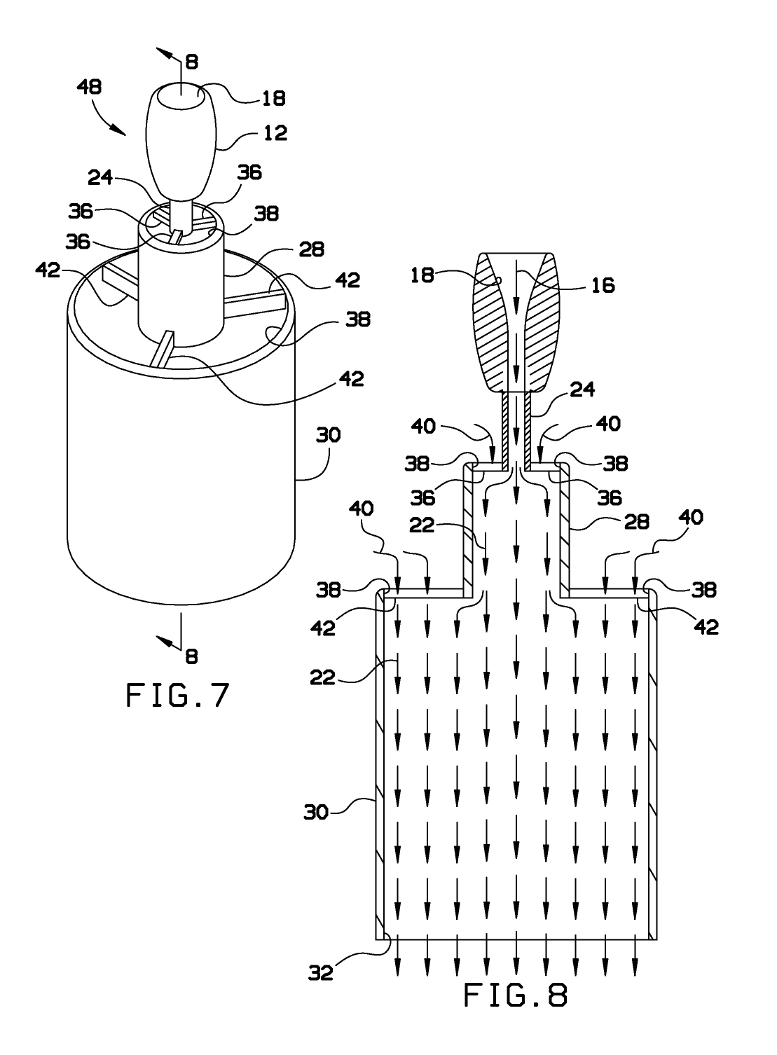

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention.

Referring now to the drawings, the following reference numbers may be used in relation to the drawings.

10: is the water jet.

12: is the jet engine.

14: is the water jet water flow.

16: is the jet engine intake air flow.

18: is the jet engine air intake.

20: is the jet engine thrust/air flow with air injection.

22: is the water jet thrust/water flow with air injection.

24: is the jet engine/water jet connection pipe.

26: is the single step cascading pipe.

28: is the primary cascading pipe.

30: is the secondary cascading pipe.

32: is the jet engine thrust/air flow outlet.

34: is the water jet thrust/water flow outlet.

36: are the jet engine/water jet support ribs.

38: is the air injection intake.

40: is the air injection intake air flow.

42: are the secondary cascading pipe support ribs.

44: is the jet engine single step cascading pipe configuration.

46: is the water jet two step cascading pipe configuration.

48: is the jet engine two step cascading pipe configuration.

This invention is an improvement on what currently exists. Existing jet engines produce much noise, turbulence, and heat. The cascading jet engine solution according to the present invention allows using jet technology in a much more efficient and safe way.

A system of improving efficiency comprises:

an impulse reaction engine 10, 12 having an exhaust;

a cascading pipe comprising:
an exhaust intake 24 having a first diameter;
approximately cylindrical walls 26, 28 having a second diameter greater than the first diameter, the approximately cylindrical walls 26, 28 having a first end and a second end 34, the first end connected to the exhaust intake 24 via a plate or ribs 36 comprising at least one orifice 38; and
a fluid injector 40 connected to the at least one orifice 38 and configured to direct fluid in a direction 22 substantially parallel to the approximately cylindrical walls 26, 28 and toward the second end 34;

wherein the exhaust intake 24 of the cascading pipe is connected to the exhaust of the impulse reaction engine 10, 12, and

wherein the fluid injector 40 is configured to inject fluid into the cascading pipe so as to cool exhaust gases emitted from the exhaust 14, 16 of the impulse reaction engine 10, 12.

The system may further comprise a second cascading pipe comprising:
second approximately cylindrical walls 30 having a third diameter greater than the second diameter, the second approximately cylindrical walls 30 having a third end and a fourth end, the third end connected to the second end of the cascading pipe via a second plate or ribs 42 comprising at least one second orifice 38; and
a second fluid injector 40 connected to the at least one second orifice 38 and configured to direct fluid in a direction 22 substantially parallel to the second approximately cylindrical walls 30 and toward the fourth end,

wherein the second fluid injector 40 is configured to inject fluid into the second cascading pipe so as to cool exhaust gases emitted from the exhaust 14, 16 of the impulse reaction engine 10, 12.

It should be understood, of course, that the foregoing relates to exemplary embodiments of the invention and that modifications may be made without departing from the spirit and scope of the invention as set forth in the following claims.

What is claimed is:

1. A method of improving efficiency, comprising the steps of:
providing an impulse reaction engine having an exhaust;
providing a cascading pipe comprising:
an exhaust intake having a first diameter;
approximately cylindrical walls having a second diameter greater than the first diameter, the approximately cylindrical walls having a first end and a second end, the first end connected to the exhaust intake via a plate comprising at least one orifice; and
a fluid injector connected to the at least one orifice and configured to direct fluid in a direction substantially parallel to the approximately cylindrical walls and toward the second end;
connecting the exhaust intake of the cascading pipe to the exhaust of the impulse reaction engine; and
injecting fluid via the fluid injector into the cascading pipe so as to cool exhaust gases emitted from the exhaust of the impulse reaction engine.

2. The method as claimed in claim 1, wherein the fluid comprises air.

3. The method as claimed in claim 1, wherein the fluid comprises water.

4. The method as claimed in claim 1, wherein the impulse reaction engine comprises a jet engine.

5. The method as claimed in claim 1, wherein the impulse reaction engine comprises a water jet.

6. The method as claimed in claim 1, further comprising the steps of:
providing a second cascading pipe comprising:
second approximately cylindrical walls having a third diameter greater than the second diameter, the second approximately cylindrical walls having a third end and a fourth end, the third end connected to the second end of the cascading pipe via a second plate comprising at least one second orifice; and
a second fluid injector connected to the at least one second orifice and configured to direct fluid in a direction substantially parallel to the second approximately cylindrical walls and toward the fourth end; and
injecting fluid via the second fluid injector into the second cascading pipe so as to cool exhaust gases emitted from the exhaust of the impulse reaction engine.

7. A system of improving efficiency, comprising:
an impulse reaction engine having an exhaust;
a cascading pipe comprising:
an exhaust intake having a first diameter;
approximately cylindrical walls having a second diameter greater than the first diameter, the approximately cylindrical walls having a first end and a second end, the first end connected to the exhaust intake via a plate comprising at least one orifice; and
a fluid injector connected to the at least one orifice and configured to direct fluid in a direction substantially parallel to the approximately cylindrical walls and toward the second end;
wherein the exhaust intake of the cascading pipe is connected to the exhaust of the impulse reaction engine, and
wherein the fluid injector is configured to inject fluid into the cascading pipe so as to cool exhaust gases emitted from the exhaust of the impulse reaction engine.

8. The system as claimed in claim 7, wherein the impulse reaction engine comprises a jet engine.

9. The system as claimed in claim 7, wherein the impulse reaction engine comprises a water jet.

10. The system as claimed in claim 7, further comprising a second cascading pipe comprising:
second approximately cylindrical walls having a third diameter greater than the second diameter, the second approximately cylindrical walls having a third end and a fourth end, the third end connected to the second end of the cascading pipe via a second plate comprising at least one second orifice; and
a second fluid injector connected to the at least one second orifice and configured to direct fluid in a direction substantially parallel to the second approximately cylindrical walls and toward the fourth end,
wherein the second fluid injector is configured to inject fluid into the second cascading pipe so as to cool exhaust gases emitted from the exhaust of the impulse reaction engine.
